(19) United States
(12) Patent Application Publication
(10) Pub. No.: US 2008/0218809 A1
(43) Pub. Date: Sep. 11, 2008

(54) Method and architecture of sending and receiving facsimile over instant messaging software

(76) Inventors: Wen Wu Chen, North York (CA); Zhi Jian Chen, Scarborough (CA); Rui Cao Mu, Richmond Hill (CA)

Correspondence Address: Bao Tran;Tran & Associates, 6768 Meadow Vista Court, San Jose, CA, 95135, US

(21) Appl. No.: 11/715,591

(22) Filed: Mar. 8, 2007

(51) Int. Cl. H04N 1/00; H04L 12/58

(52) U.S. Cl. 358/407

(57) ABSTRACT

Systems and methods are disclosed for provisioning a facsimile (fax) service for a client computer over instant messaging software, services or networks.

### BACKGROUND

The invention relates generally to the provisioning facsimile (fax) service with instant messaging services.

A fax (short for facsimile and sometimes called telecopying) is the telephonic transmission of scanned-in printed material (text or images), usually to a telephone number associated with a printer or other output device. The original document is scanned with a fax machine, which treats the contents (text or images) as a single fixed graphic image, converting it into a bitmap. In this digital form, the information is transmitted as electrical signals through the telephone system. The receiving fax machine reconverts the coded image and prints a paper copy of the document.

With the advent of personal computers, a digital document can be communicated inexpensively through a fax modem controlled by a personal computer. The personal computer rasterizes the document, provides the file to the fax modem and the fax modem sends the file in accordance with a fax protocol to a remote fax machine through the PSTN to transmit and receive faxes. The computer and fax modem combination eliminates the need for a separate fax machine, but still requires a phone line. Hence, such fax modems can cause problems when the user uses the same phone line for phone calls or Internet access.

Additionally, certain fax machines can connect to an analog telephone adaptor (ATA) which in turn connects to a packet switched network and/or the Internet, to deliver fax using the Internet protocol. These machines remove the need for dedicated phone lines, but still require the use of fax machines and require that users be physically present in order to send/receive fax. Also, the quality of fax transmission may fluctuate due to the lack of quality and/or stability of the Internet access network.

In another alternative, fax service providers have provided users with the ability to email documents to the fax service provider. The provider then connects to a PSTN trunk line and transmits the fax on behalf of the user. The provider can set up relationship between a fax number and a user's email account, and enables the user to send/receive fax as file attachment to an email.

### SUMMARY

In one aspect, a method for provisioning a facsimile (fax) service for a client computer includes receiving a fax request over an instant messaging (IM) channel; authenticating the client computer; and performing the fax request through a fax server.

Implementations of the above aspect may include one or more of the following. The process can include communicating with a client computer through IM. The communications with the IM client computer can be done over the Internet. The fax transmission can be stored as an image file. The process can include receiving a send fax request and sending the fax to a destination using the fax server. The process can include sending client identification, the send fax request and a fax image file to the fax server. Upon authorization, the send fax request can be sent to a queue of fax modems for transmission. The fax transmission result can be collected and the client can be notified of the result. The process can include a send fax wizard to generate a fax transmission, wherein the send fax wizard prompts the client to make a fax cover page with a descriptive text; a recipient name, and a recipient fax number and wherein the send fax wizard rasterizes the fax cover page and a document. In another implementation, the process includes receiving a fax transmission; determining a destination fax number and identifying a recipient; storing the fax transmission on a server; notifying the recipient of the fax transmission using an IM service; and downloading the fax transmission from the server to an IM client computer. The destination fax number can be detected using one of: a direct-inward-dial (DID) identification, dual tone multi-frequency (DTMF) identification. The fax server can compose a data stream in an image format.

In another aspect, a system to provision a facsimile (fax) service for an instant messaging (IM) client includes a fax server coupled to a plurality of fax modems to communicate fax data over a circuit switched network; and an IM server coupled to the fax server, said IM server receiving a fax request from an IM client; authenticating the IM client; and performing the fax request through the fax server.

Implementations of the above aspect may include one or more of the following. A fax file server can be connected to the fax server. A fax database server can also be connected to the fax server. The fax server receives a fax transmission; determines a destination fax number and a recipient; and stores the fax transmission in a folder securely accessible by the recipient. The IM server notifies a recipient of the fax transmission using an IM service and allows downloading the fax transmission from the server to an IM client computer. The IM server can receive a send fax request for a fax document from the IM client and the fax server then communicates the fax document over the circuit switched network. The IM server can receive a send fax request for a fax document from a first IM client to a second IM client and in response, the IM server makes the fax document accessible to the second IM client and notifies the second IM client to access the fax document. The fax server collects fax transmission result and the IM server notifies the IM client computer of the result. A send fax wizard can generate a fax transmission, wherein the send fax wizard prompts the client to make a fax cover page with a descriptive text; a recipient name, and a recipient fax number and wherein the send fax wizard rasterizes the fax cover page and a document.

In yet another aspect, a system is disclosed for provisioning facsimile service over IM software. The system includes one or more IM clients, an IM server and collaborating mechanism for sending and receiving facsimile over instant messenger. Architectural designs of the IM client software and the IM server and their interaction mechanism to make them suitable for sending/receiving fax are also disclosed.

In another aspect, the system enables an IM client to send and receive facsimile. The users of such instant messaging software can send/receive fax to/from the users of the same IM software, and to/from the external fax device/service that are located outside such IM service, including to/from the traditional fax machine, Fax over IP device/service, and email/fax service. The design of IM client consists of a fax function module with major sub modules of a signature image file maker, fax file folders, image file folders, file converter, and a fax sending wizard. All sub modules work together to interact with IM server, generate fax files to be sent and receive fax image files from fax server.

In yet another aspect, the IM server architecture includes a main IM server, an IM user database and a fax server communicating with each other for authentication, authorization and accounting (AAA) of fax users, and for defining the fax sending/receiving mechanism, the file management system and its relation with user accounts. The fax server further connects to external networks of PSTN and internet through T.30 and T.38 modems to ensure seamless fax transmission between internal IM users and external fax machines. In addition, the fax server communicates with the main IM server to indicate real-time progress of fax transmission, which is then delivered to an IM client.

Advantages of the system may include one or more of the following. The system, known as Vbuzzer Messenger, provides fax transmission capability together with instant messaging and internet telephony. The system eliminates the need for dedicated fax machines where the user has to be physically present to fax. Additionally, the system provides real-time progress indications and confirmations to the user such as “fax is in the waiting queue”, “sending fax now”, “transmission completed”, “transmission failed”, “you have an incoming fax,” among others. The system is also highly manageable from the user's perspectives. For example, the system allows cancellation immediately after the fax was submitted for sending. The system also stores and indexes the sent/received faxes in an organized file folder.

In sum, the system provides a manageable, synchronized, interactive fax transmission mechanism for IM users. The system brings the advantages of real-time manageability, synchronization and interactivity of instant messaging to fax applications.

### BRIEF DESCRIPTION OF THE DRAWINGS

FIG. 1 is a system diagram of an exemplary fax over instant messaging architecture.

FIG. 2 is a flow diagram of an exemplary process for sending/outgoing faxes.

FIG. 3 is a flow diagram of an exemplary process for receiving/incoming faxes.

FIG. 4 is a diagram of an exemplary client software architecture illustrating a fax module and its sub modules which work collaboratively to manage the sending/receiving a fax using the IM client.

FIG. 5 is a flow diagram of an exemplary process for sending outgoing faxes at the IM client level.

FIG. 6 is a flow diagram of an exemplary process for receiving incoming fax flows at the IM client level.

### DESCRIPTION

Referring now to the drawings in greater detail, there is illustrated therein structure diagrams for a fax transaction system and logic flow diagrams for the processes a computer system will utilize to complete various fax transactions with instant messaging services. The system is a client-server system, and it will be understood that the client program is run on a computer that is capable of communication with the server over a network, as will be more readily understood from a study of the diagrams. The system described below is called “Vbuzzer Messenger” for purpose of reference and explanation.

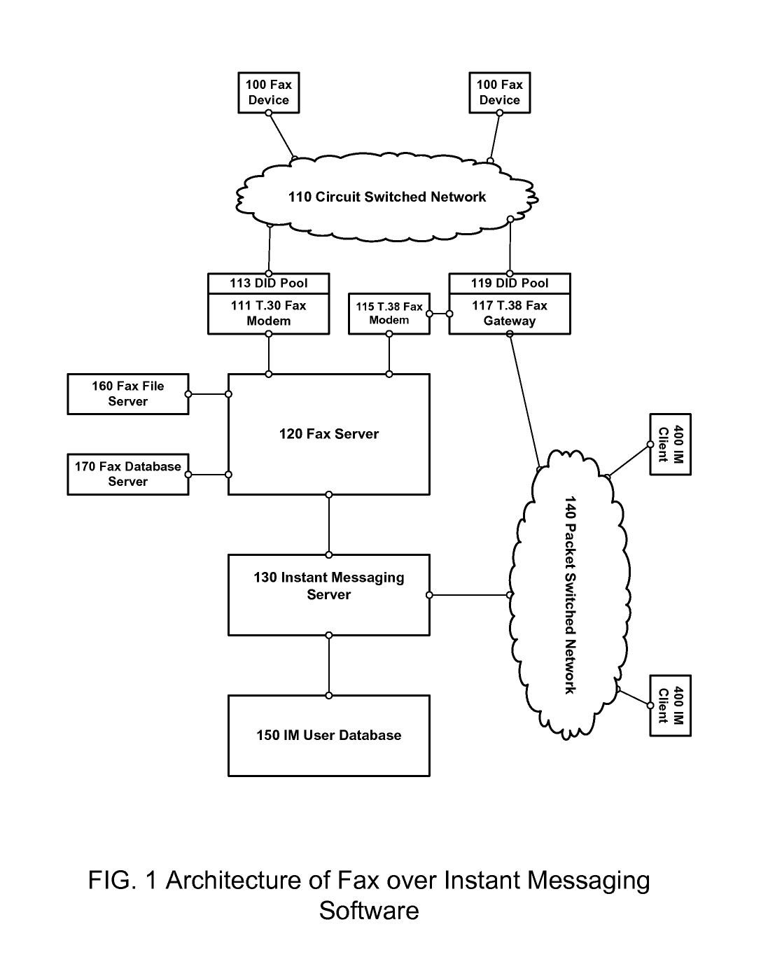

FIG. 1 is an illustration of an embodiment of a Fax-Over-Vbuzzer instant messaging (IM) architecture that operates in accordance with one aspect of the present invention. An IM server 130 connects to a packet switched network 140 for providing instant messaging services for the IM clients 400 connected to the server 130 over the packet switched network 140, which can be a wide area network (WAN) and/or the Internet. The IM server 130 provides users with services such as authentication, login, contact list, instant exchange of text messages and/or files, and Internet telephony.

The IM server 130 communicates with an IM user database 150 that provides user authentication, authorization, and accounting for the various free and paying services, including but not limited to, fax services that the IM server 130 provides. In this embodiment, the IM user database 150 also maintains data on users who subscribe to the fax service for purposes of user authentication, authorization, and accounting (AAA).

A fax server 120 connects and works with the IM server 130 and the IM user database 150. The fax server 120 works as a “command and processing center” for storing, indexing, sending, receiving fax image files as well as processing fax transmission status. The fax server 120 interfaces with network devices such as T.30 modem 111 and T.38 modem 115, among others. These modems in turn are connected respectively to a circuit switched network 110 such as the POTS network and packet switched networks such as Internet. The fax server 120 collaborates with the IM server 130 to notify the server 130 with events and status on the storing, indexing, sending and receiving of fax image files. The IM server 130 in turn notifies such events and status to the IM Client 400 through instant messages. The IM server 130 also sends action requests to the fax server 120 for the fax server 120 to execute all fax-related commands the IM server 130 receives from one or more IM Clients 400.

The fax server 120 accesses the IM user database 150 for user authentication, authorization, and accounting (AAA). For example, upon receiving a request for sending a fax transmission, the fax server 120 queries the IM user database 150 to get the remaining balance from a client account in order to determine if there is sufficient monetary value in the account to cover the fax transmission charge(s). Also, upon receiving a fax from external networks, the fax server 120 queries the IM user database 150 to determine if an incoming fax can be sent over IM (peered) to a user, and if so, which user the fax is peered to.

In one embodiment, the IM user database 150 is a relational database storing necessary information of all instant messaging users. In one embodiment, the database contains a username, password, vphone, vfax, balance, home phone, mobile phone, office phone, street, city, state/province, country, and zip code, among others. The user name is provided by the IM user at the time of his or her registration, and each user name is unique. Vphone is the voice over IP (VOIP) phone number that the IM user has subscribed to (or null if there is no VOIP subscription), and is unique at any given time. Vfax is the fax number that the IM user subscribed to through the IM service provider and is also unique at any given time. If the user does not subscribe to the fax service from the IM service provider, the field is null. The balance is the monetary value representing the current credit the user has remaining in his or her account. Other fields include information entered by the user at or after the time of registering the IM account, and the information is unique and can be null if not filled by the user.

Each IM client 400 who subscribes to the fax service(s) from the IM service provider has a one-to-one relationship between a user name and a fax number. When the fax server 120 receives a send fax request from the IM server 130, the fax server 120 also receives the user name and fax number (if available) from the IM server 130 so that the fax server 120 can query the IM user database 150 and check if sufficient balance is available for executing the fax request. If the user passes the authorization, his user name and/or fax number (if available) is then passed through to the external network 110 by the fax server 120. When the fax server 120 receives a fax image file from an external network such as the circuit switched network 110 and the packet switched network 140, the fax server 120 queries the IM user database 150 to identify the recipient's user name by the recipient's fax number, based on their one-to-one relationship.

The fax server 120 also communicates with a fax file server 160, which is a file server that contains file folders for storing fax image files including those sent and/or received for each user name. Whenever a fax is sent or received, the fax server 120 opens a user name-based file folder in the file server 160 if the folder does not exist. The file server 160 provides the ability to store each user's incoming and outgoing fax image files in the server, in addition to the files stored in the user's IM client.

The fax server 120 also communicates with a fax database server 170, which is a fax database server contains information about the storage of file image files sent and received. The information captured by server 120 includes user name, fax file and store path, and file server IP address written by the fax server 120. The fax database server 170 will subsequently be queried by the IM Client 400 to determine where and how to fetch the fax image files sent and/or received.

The fax server 120 is also connected to the external circuit switched network (public switched telephone network (PSTN) or plain old telephone system (POTS)) 110 either through a T.30 fax modem 411 with a DID Pool 113 attached to it (a number of Direct Inward Dial, or more commonly speaking, a pool of telephone numbers), or through a T.38 fax gateway 115 with a DID Pool 117 attached to it. The circuit switched network 110 is connected to a plurality of fax machines 110 through regular phone lines subscribed from the local telephone carriers.

The T.30 fax modem 111 is a fax executing device that transmits fax over the POTS or PSTN 110. The fax modem 111 can be an analog fax modem (one circuit connected to PSTN) or a digital trunk fax modem (digital trunk line such as a digital Ti connected to PSTN). The fax modem 111 executes all fax transmitting operations according to fax protocol T.30.

The fax server 120 can also be connected to a T.38 fax gateway 115 either through direct cable connection or through a wide area network 140 as shown in FIG. 1. The T.38 fax gateway 115 executes all operations related to transmitting fax over internet 140 and to/from PSTN 110. Any commercially available T.38 fax gateways can be used, many of which are integrated together with voice over IP gateways.

To connect to the PSTN 110, both T.30 modem 111 and T.38 modem 115 need to be connected to analog phone lines or trunk lines that assigned by telephone carriers. By connecting to the PSTN, a pool of fax numbers (DID pool 113 and 117) are assigned to the respective lines, these fax numbers will be further assigned by the instant messaging service provider to the users who subscribed to IM fax services. Therefore, a one to one relationship is set up between a fax number and a user name.

The network topology shown in FIG. 1 provides a localized and centralized deployment where the servers are connected locally with each other. However, it is understood that the IM fax system can well be achieved through a distributed network topology where the above servers are connected remotely through and across a wide area network (WAN). Also, these servers can be deployed in clusters to provide for redundancy. With the above illustrated architecture of software system, fax can be transmitted, sent and received, over instant messenger protocols.

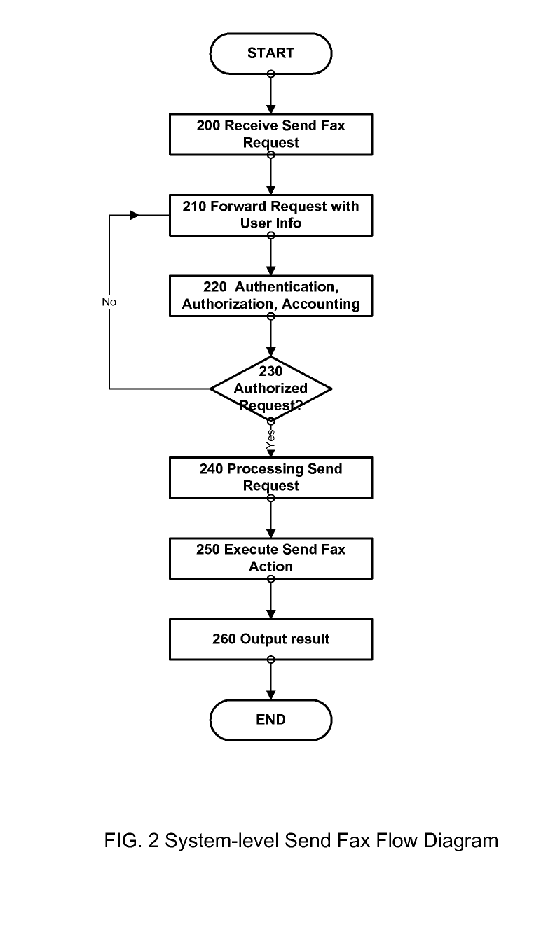

FIG. 2 is a flow diagram illustrating the system operations flow of sending fax to external networks such as PSTN 110 and Internet 140. In block 200, the IM server 130 receives a fax image file together with a request for sending a fax from a IM Client 400. In block 210, since the IM Client 400 has logged-in with the IM server 130, the IM server 130 already has user information such as user name, the IM server 130 forwards the information as well as the send fax request and the fax image file to the fax server 120 for processing. In block 220, the fax server 120 receives the send fax request, fax image file, destination fax number, and user information. With the information, the fax server 120 queries the IM User Database 150 to check if the request is authorized and if sufficient balance exists in the user account to pay for the send request.

In block 230, the IM User Database 150 processes the query and returns a result. If the query fails, the server 120 will notify the IM Server 130 which will further notify the IM Client 400. In block 240, if the send request is authorized, fax server 120 will process the request, e.g. check available modems, available channels, the files waiting to sent etc and put the new request in the queue accordingly. In block 250, one modem such as the T.30 modem 111 or T.38 modem receives the commands of sending fax from the fax server 120 executes the sending operation and reports the result to the server 120. In block 260, modems 111/115 receives signals indicating the result of sending operations and they in turn forward the indications to fax server 120 to confirm the result. The indications are further forwarded to IM server 130 and IM client 400.

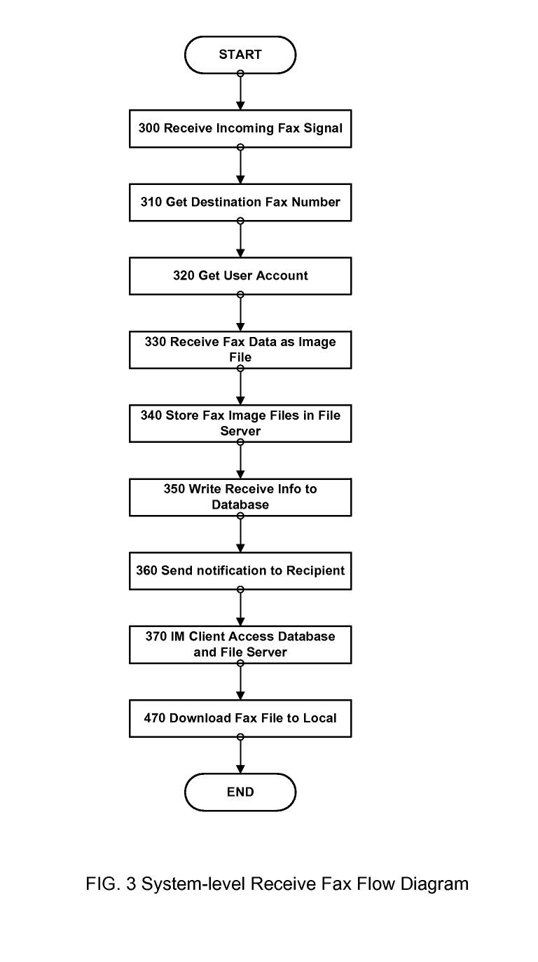

FIG. 3 is a flow diagram illustrating the system operation in receiving faxes for its users. In block 300, T.30 modem 111 and/or T.38 modem 115 receives an incoming fax signal from fax devices in the external networks PSTN 110 or Internet 140. In block 310, while receiving the incoming fax signal, the modems 111/115 also detect the destination fax number by means of direct-inward-dial (DID) or dual tone multi frequency (DTMF). The destination fax number is forwarded to fax server 120.

In block 320, fax server 120 queries IM user database 150 to get the user name of the IM client 400 that corresponds to the destination fax number. In block 330, based on the username it gets in the above step, the fax server 120 creates a file folder in fax file server 160 if the folder does not exist yet. Next, the fax server 120 starts to receive and data stream from modems 111/115 and the server 120 composes the data stream in an image format files such as TIF or TIFF files. In block 340, the fax server 120 stores the file image file into the folder in file server 160. In block 350, the fax server 120 writes the received information to the fax database server 170. Such information includes recipient's username, fax image file ID and store path, file server ID and IP address, among others.

In block 360, the fax server 120 sends a notification to the IM server 130, which in turn forwards the notification to the IM Client 400 that it has received a fax. In block 370, the IM Client 400 access the fax database to get information to retrieve the fax, including a fax image file ID, its store path, file server ID and its IP address, for example. In block 380, the IM Client 400 accesses the file server 120 and the fax image file according to the information acquired in block 370. The IM Client 400 can either view the fax image file on the file server 120 or download the fax image file to a folder in the local computer hosting the IM client 400.

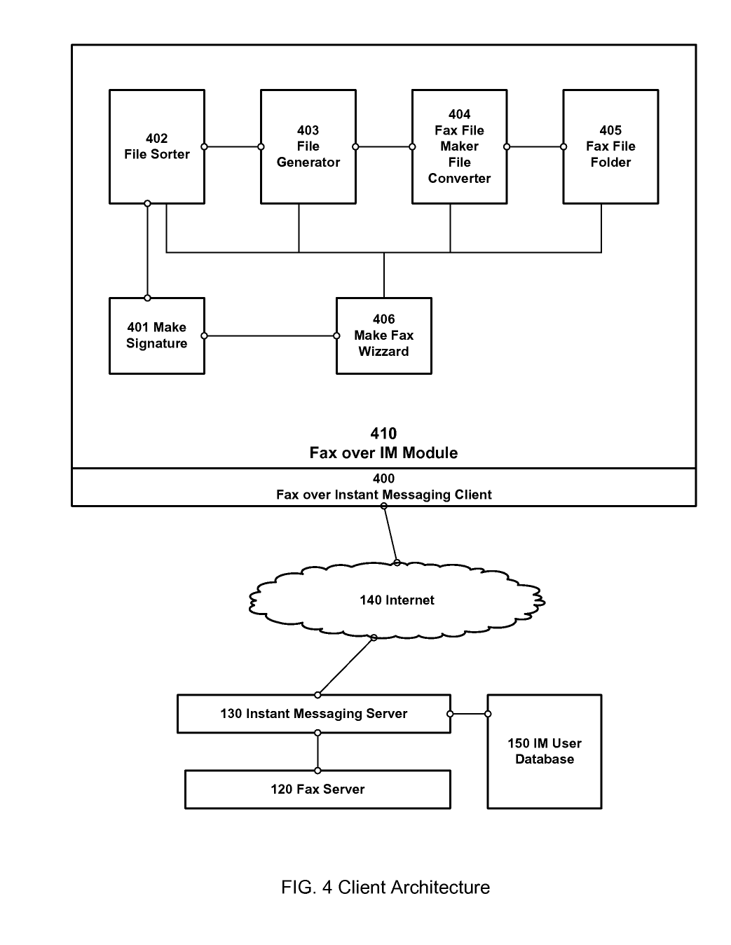

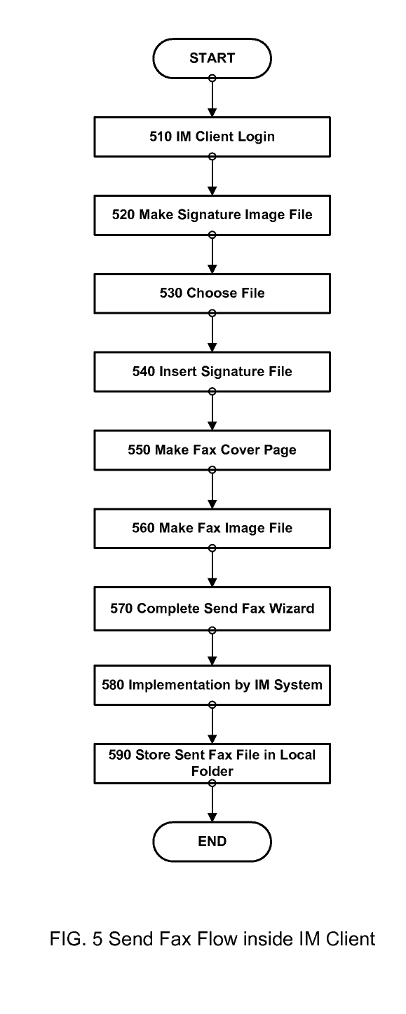

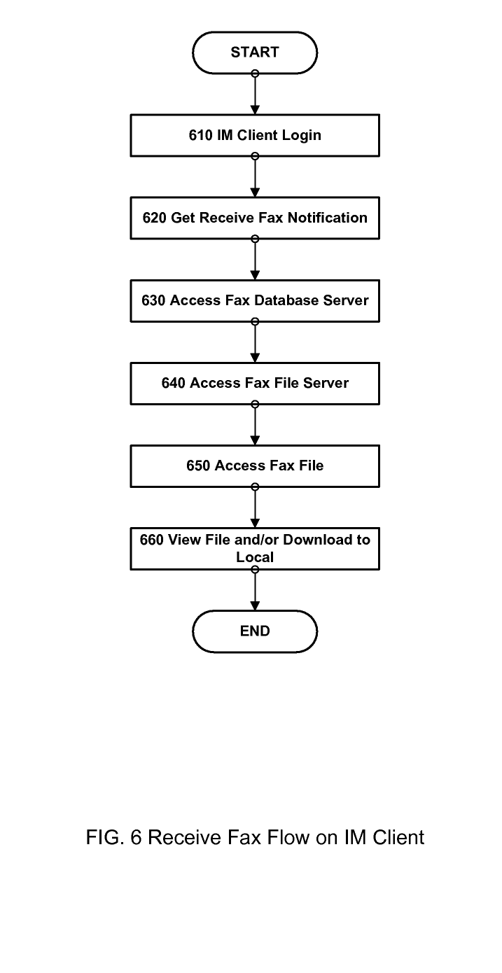

FIGS. 1-3 detail the architecture and mechanism to transmit fax over instant messaging software at the server/system level. Next, the architecture and processes to render a fax over IM in the IM client software are shown in FIG. 4, FIG. 5 and FIG. 6 and described below.

The IM client 400 software has a server software component as well as a client software component. During operation, each user of the IM software interacts with the client software directly. FIG. 4 is a diagram of an IM client architecture that provides fax functionality over an instant messenger service. A Fax over Instant Messaging client 400 is an IM client software running on the user's computer.

Initially, the IM client 400 logs into the IM Server 130 through a connection to the Internet 140. In one embodiment, the login to the IM Server 130 consists of a series of user authentication and service authentication between the IM Client 400 and the IM Server 130. When the IM Client 400 is successfully logged in, the Client 400 has already passed a rigorous authentication process and the information associated with the Client 400 is already available to the IM Server 130.

In one embodiment, an IM Client 400 called Vbuzzer Messenger has functional modules to execute basic applications instant messaging, file exchange, and voice calls between users. The IM client 400 includes a Fax over IM Module 410, which is designed to supplement to the IM mainframe. As shown in FIG. 4, the Fax over IM Module 410 contains various sub modules that collaborate with each other to provision fax with the IM Client 400 as well as with the IM Server 130.

The Fax Over IM Module 410 includes a Signature Maker Module 401, which is a sub module to make the user's signature image file. It manages a wizard for guiding the user through a number of on-screen operations to make a signature image file. The user is able to draw his/her signature by moving the computer mouse. Alternatively, user can make a signature on paper, then scan it and input it into 401. In either case, a signature image is made and stored in the sub module 410.

FIG. 4 also shows a File Sorter 402, which is a sub module to choose a file intended to be sent as a fax from the user's computer. Additionally, a Fax File Generator 403 is provided as a sub module that imports the user's signature image and inserts the signature image into another file. After the insertion, the Fax File Generator 403 generates a new image file of the fax to be sent.

The Fax over IM Module 410 also contains a File Maker/Converter 404, which is a sub module that converts files generated by the Fax File Generator 403 and the fax cover page file generated by the Make Fax Wizard 406 into one file in a format that is suitable for fax transmission. In one implementation, the files are converted into a TIFF format, and depending on the type of fax server 120, files can be converted into other formats such as PDF or PostScript. In one embodiment, the Fax File Maker/Converter 404 is formatted as a virtual printer but the File Maker/Converter can also be in other formats that can suitably convert the file. The formats of source files that can be converted include text file, MS Word, MS Excel, PDF, and PostScript, among others. The source formats can be expanded as necessary so that the File Converter 404 can convert files of different format into one uniform format suitable for fax transmission.

The Fax over IM Module 410 also includes a File Folder 405, which is a sub module for storing Fax Image Files. In one embodiment, the files are arranged by their outgoing and incoming status. In this embodiment, outgoing and after-conversion image files are stored in the folder, as well as all incoming received image files are stored in the folder, each in different sub folders for sorting purpose. The user will access this folder as their fax file pool reflecting the history of sent/received fax.

A Send Fax Wizard 406 is a sub module that contains a series of on-screen user interfaces (UIs) for guiding the user through all operations related to sending a fax. The Wizard covers the operations of selecting a file to be sent, making a cover page, converting the file, and entering the destination information such as destination fax number.

With the above described client software, a fax can be generated within the client software for the transmission (sending and receiving) between the client software and the servers through system software.

FIG. 5 illustrates an exemplary operation flowchart to generate and send a fax from the IM client software. In block 510, the IM Client 400 communicates with the IM Server 130 and is suitably authenticated by the IM Server 130. In block 520, the Make Signature sub-module 401 helps the user to generate a copy of his/her signature as a graphic/image, and this graphic/image will be saved and stored as his/her signature image file. In block 530, the File Sorter 402 prompts the user to choose a file stored in the local computer to be faxed. In block 540, with the help of Fax File Generator 403, a user can copy and paste the signature image into a predetermined location in the chosen file and generate a new file containing the signature image to be faxed. In block 550, the Send Fax Wizard 406 prompts the user to make a fax cover page, with relevant information such as sender's name, company, fax number, data and time, subject of the fax, brief introductory content of the fax etc; as well as information about the recipient such as name, company, address, fax number etc. In block 560, the File Converter 404 converts the file generated in 530 and 540 and combines them into one fax image file in a suitable format such as TIF, TIFF, PDF, and/or PostScript. In block 570, after the final fax image file is generated, the user is prompted to complete the Send Fax Wizard 406 by entering destination fax number and confirming the fax request. In block 580, the Send Fax request is submitted to the IM Server 130 for the system to process the request in accordance with the work flow illustrated in FIG. 2. In block 590, the final fax image file is stored in File Folder 405 as history record for user to access and review as needed. The work flow of Send Fax in the client software is completed after block 590.

In one embodiment, if a fax recipient is not found in the IM user database 150, the fax server 120 sends the fax over the circuit switched network 110. Alternatively, if the recipient is listed in the IM user database 150, the recipient is an authorized IM user in the provider's network and he or she has a fax number from the IM service, the system copies the fax image file directly into the fax file server 160 and notifies the recipient's IM client 400 to retrieve and view the received fax. Thus, the process of sending a fax between internal users is simply a file transfer over IM where the transferred files are fax image files.

FIG. 6 is a diagram of an exemplary process for receiving fax by the IM Client 400. In block 610, the IM Client 400 logs in with the IM Server 130. In block 620, the IM Client 400 receives a notice that a fax has been received. In block 630, the IM Client 400 accesses the Fax Database Server 170 to fetch the location of the received fax file using a file ID, store path, ID of File Server 160, and IP address, for example. In block 640, the IM Client 400 accesses the File Server 160 and in block 650, the IM Client 400 accesses the fax file stored on File Server 160. In block 660, the IM Client either views the received fax file on File Server 160, or downloads it to the folder in the local computer for viewing.

It is understood that the present invention may be embodied in other forms and configurations other than the exact specifications and system layouts of the Vbuzzer Messenger as described below. Further, although the present invention is described through a centralized server architectural design, principles of the invention apply to distributed server architecture as well as peer to peer architecture. Moreover, we intend not to specify the type of networks because the invention of fax over instant messaging software applies to all networks in general, e.g. fix line networks and wireless networks, and on all devices, e.g. desktop computers, laptop computers, mobile devices etc as long as they run instant messaging software on them.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the IM Client 400 is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for provisioning a facsimile (fax) service for a client computer, over instant messaging services or networks, comprising:
a. receiving a fax request over an instant messaging (IM) channel;
b. authenticating the client computer; and
c. performing the fax request through a fax server.

2. The method of claim 1, comprising communicating with a client computer through IM.

3. The method of claim 1, comprising communicating with an IM client computer over the Internet.

4. The method of claim 1, wherein the fax transmission is stored as an image file.

5. The method of claim 1, comprising:
a. receiving a send fax request;
b. sending the fax to a destination using the fax server.

6. The method of claim 5, comprising sending client identification, the send fax request and a fax image file to the fax server.

7. The method of claim 5, comprising converting the fax image file into one or more transmission compatible file types using an IM client software

8. The method of claim 5, comprising collecting a fax transmission result and notifying the client of the result.

9. The method of claim 5, comprising providing a send fax wizard to generate a fax transmission.

10. The method of claim 9, wherein the send fax wizard prompts the client to make a fax cover page with a descriptive text; a recipient name, and a recipient fax number and wherein the send fax wizard rasterizes the fax cover page and a document.

11. The method of claim 1, comprising:
a. receiving a fax transmission;
b. determining a destination fax number and identifying a recipient;
c. storing the fax transmission on a server;
d. notifying the recipient of the fax transmission using an IM service; and
e. downloading the fax transmission from the server to an IM client computer.

12. The method of claim 11, wherein the fax server composes a data stream in an image format.

13. A system to provision a facsimile (fax) service for an instant messaging (IM) client, comprising:
a. a fax server coupled to a plurality of fax modems to communicate fax data over a circuit switched network; and
b. an IM server coupled to the fax server, said IM server receiving a fax request from an IM client; authenticating the IM client; and performing the fax request through the fax server.

14. The system of claim 13, comprising a fax file server coupled to the fax server.

15. The system of claim 13, comprising a fax database server coupled to the fax server.

16. The system of claim 13, wherein the fax server receives a fax transmission;
determines a destination fax number and a recipient; and stores the fax transmission in a folder securely accessible to the recipient.

17. The system of claim 13, wherein the IM server notifies a recipient of the fax transmission using an IM service and allows downloading the fax transmission from the server to an IM client computer.

18. The system of claim 13, wherein the IM server receives a send fax request for a fax document from the IM client and the fax server communicates the fax document over the circuit switched network.

19. The system of claim 13, wherein the IM server receives a send fax request for a fax document from a first IM client to a second IM client, the IM server making the fax document accessible to the second IM client and notifying the second IM client to access the fax document.

20. The method of claim 13, wherein the fax server collects fax transmission result and the IM server notifies the IM client computer of the result.

21. The method of claim 13, comprising providing a send fax wizard to generate a fax transmission, wherein the send fax wizard prompts the client to make a fax cover page with a descriptive text; a recipient name, and a recipient fax number and wherein the send fax wizard rasterizes the fax cover page and a document.
